(19) United States
(12) Patent Application Publication
(10) Pub. No.: US 2025/0168559 A1
(43) Pub. Date: May 22, 2025

(54) SIGNAL PROCESSING APPARATUS

(71) Applicant: DENSO TEN Limited, Kobe (JP)

(72) Inventors: Takashi FUKUDA, Kobe (JP); Masashi Nakamura, Kobe (JP); Masaki Nakagawa, Kobe (JP); Takaaki Nakanishi, Kobe (JP)

(73) Assignee: DENSO TEN Limited, Kobe (JP)

(21) Appl. No.: 18/821,230

(22) Filed: Aug. 30, 2024

(30) Foreign Application Priority Data
Nov. 22, 2023 (JP) 2023-198317

(51) Int. Cl. H04R 3/00; H04R 1/02

(52) U.S. Cl. CPC H04R 3/00; H04R 1/025; H04R 2499/13

(57) ABSTRACT

A signal processing apparatus including a controller configured to: (i) acquire a sound source signal for reproducing sound in a vehicle; (ii) acquire seat information indicating a state of a seat in the vehicle; (iii) determine parameters for reproduction based on the seat information; and (iv) generate sound signals for outputting the sound from a plurality of speakers provided in the vehicle based on the sound source signal and the parameters.

### BACKGROUND OF THE INVENTION

### Field of the Invention

The invention relates to a signal processing apparatus, a signal processing method, and a sound system.

### Description of the Background Art

In a case where a sound system reproduces music stored in a medium, such as a CD, a DVD, etc., for example, a left speaker and a right speaker are disposed separated from each other in an audio room environment, and the sound system causes the left and right speakers to output sound on left and right channels, respectively. When a user (listener) listens to the sound at a listening point, the user senses a direction and position of a sound source by both ears so as to listen to realistic music. In this case, the listening point is assumed to be, for example, a predetermined distance (e.g., 1 to 1.2 times) depending on a distance between both speakers and equidistant from each of the speakers.

On the other hand, in the sound system to be mounted in a vehicle, since the user takes a seat in the vehicle and receives the sound, a position of each seat becomes a listening point. In this case, for example, a driving seat in a right-hand drive vehicle has a longer distance from the left speaker than the right speaker and has a shorter distance from the right speaker than between the left and right speakers. Thus, the driving seat in the right-hand drive vehicle is positioned off an ideal listening point. As a result, the sound system to be mounted in the vehicle may employ a technology that corrects a difference in the distance from each of the speakers by adjusting a time alignment of the sound to be output from each of the speakers so as to enable highly realistic sound reproduction.

An in-vehicle sound system disclosed in the Japanese Published Unexamined Patent Application No. 2006-324712 includes a sound processor that performs sound correction process on a sound signal, a seat controller that transmits a control signal to the sound processor, and a main controller that acquires the entire output state of a plurality of seat speakers provided in a vehicle cabin as output information. The seat controller receives the output information from the main controller and transmits a control signal corresponding to the output information to the sound processor. The sound processor includes a plurality of sound correction filters corresponding to the output information and performs the sound correction process of the sound signal by extracting optimal sound correction filters based on the control signal. As a result, in the in-vehicle sound system according to the Patent Document 1, sound environment in a specific seat is optimized regardless of sound output states in other seats.

The Japanese Published Unexamined Patent Application No. 2019-161394 discloses a call module that reads parameters corresponding to a model of a vehicle to which the call module is attached from a table in which a distance between the call module and an occupant, a mounting angle of a speaker, and parameters of a sound volume or effect are stored for each vehicle model, and automatically adjusts sound parameters of a microphone and the speaker according to the read parameters.

In the system in which the sound parameters are adjusted depending on a distance between each speaker and a seat disposed in the vehicle, when a user changes a state of the seat, such as a position of the seat or an angle of a seat back, from a predetermined state, a positional relationship between the speakers disposed in other places than the seat and the user sitting in the seat changes. Thus, there has been a problem that the time alignment is broken and sound interference is caused, which results in loss of sound quality.

### SUMMARY OF THE INVENTION

According to one aspect of the invention, a signal processing apparatus includes a controller configured to:
(i) acquire a sound source signal for reproducing sound in a vehicle;
(ii) acquire seat information indicating a state of a seat in the vehicle;
(iii) determine parameters for reproduction based on the seat information; and
(iv) generate sound signals for outputting the sound from a plurality of speakers provided in the vehicle based on the sound source signal and the parameters.

It is an object of the invention to provide a technology that reproduces sound by using appropriate sound parameters in accordance with a state of a seat when reproducing the sound in a vehicle.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates a schematic configuration of a sound system mounted in a vehicle;

FIG. 2 schematically illustrates an arrangement of speaker units included in the vehicle;

FIG. 3 is a functional block diagram of a head unit;

FIG. 4 illustrates a positional relationship between a user sitting in a seat and the seat;

FIG. 5A illustrates a positional relationship between an angle of a seat back and a position at which a sound image is localized;

FIG. 5B illustrates a positional relationship between an angle of a seat back and a position at which a sound image is localized;

FIG. 6 is a configuration diagram of the sound system including the head unit;

FIG. 7 is a flowchart of a signal processing method according to this embodiment performed by a controller based on a signal processing program;

FIG. 8 illustrates a configuration of a head unit according a second embodiment; and

FIG. 9 illustrates a flow of a signal processing method performed by the head unit according to the second embodiment.

### DESCRIPTION OF THE EMBODIMENTS

Embodiments of a signal processing apparatus, a signal processing method, and a sound system disclosed in the present application will be described below with reference to the accompanying drawings. This invention is not limited to the embodiments described below.

### First Embodiment

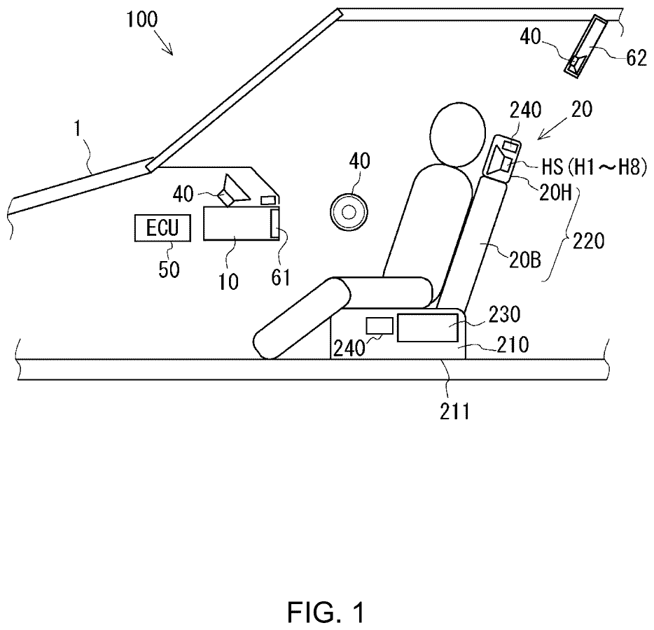

FIG. 1 illustrates a schematic configuration of a sound system 100 mounted in a vehicle 1. As illustrated in FIG. 1, the sound system 100 includes a head unit 10, speaker units 40, and an ECU 50.

The head unit 10 uses a storage medium, such as a CD, DVD, or semiconductor memory, as a sound source, reads contents stored in the storage medium, reproduces sound signals, and outputs sound from a plurality of the speaker units 40. In the sound system according to this embodiment, each of the plurality of the speaker units 40 (hereinafter, also referred to as headrest speakers HS) is embedded in a headrest 20H of each seat 20 in the vehicle 1, and the sound is mainly output from the headrest speakers HS to a user sitting in each seat 20. In this case, although the headrest speakers HS are positioned behind the user, sound control is performed to localize a sound image in front of the user using a head related transfer function (HRTF). A specific control method will be described later.

The sound source that supplies contents to the head unit 10 is not limited to the storage medium and may be a tuner or a network receiver. For example, the head unit 10 may receive broadcasts of radios and televisions and generate the sound signals of these broadcasts (contents). Furthermore, the head unit 10 may receive contents from a smartphone or music player of the user, or a server on a network, and generate the sound signals based on these contents. When the contents contain image signals, the head unit 10 may reproduce the image signals together with the sound signals and display an image.on displays 61, 62. The head unit 10 according to this embodiment may be an electronic equipment (in-vehicle apparatus) with integrated audio, visual, and navigation systems that includes, in addition to an audio function, a visual function, such as video reproduction and display of TV broadcasts, and a navigation function that sets destinations and transit points in response to passenger operations and provides route guidance (navigation) to the destinations.

Each seat 20 has a seat portion 210 on which the user sits, a seat back (back portion) 220 rotatably connected to a rear end of the seat portion 210, an actuator 230, and a seat sensor 240. The seat portion 210 is slidably attached to a rail provided on a side of the vehicle by a bottom 211 of the seat portion 210. Since the rail according to this embodiment is provided along a front-rear direction of the vehicle 1, each 20 is also movable in the front-rear direction along the rail. The seat portion 210 has a height adjustment mechanism to adjust a height of a seat surface. Each seat 20 may have a rotating mechanism that rotates around a vertical axis. For example, the rotating mechanism is capable of rotating 90° from a front directed state in which the user sitting in the seat faces in a traveling direction of the vehicle to a side directed state or rotating 180° from the front directed state to a back directed state.

The seat back 220 has a backrest 20B in contact with a back of the user sitting in the seat 20, and the headrest 20H that is attached to an upper end of the backrest 20B and located back of a head of the user. The headrest 20H may be formed integrally with or separately from the backrest 20B. The headrest 20H formed separately from the backrest 20B may be height adjustable to the backrest 20B. The seat back 220 is rotated back from a vertical standing position to a substantially horizontal lying position relative to the seat portion 210. Thus, the seat back 220 has an adjustment mechanism (reclining mechanism) that adjusts this rotation angle to maintain any desired position.

The actuator 230 is mounted in each seat and drives the seat portion 210 back and forth along the rail on the side of the vehicle. The actuator 230 rotates the seat back 220 relative to the seat portion 210. Furthermore, the actuator 230 moves the seat surface up and down so as to change a distance between the bottom of the seat portion 210 and the seat surface. When the seat 20 has the rotating mechanism that rotates around the vertical axis, the actuator 230 may drive the seat 20 to rotate around the vertical axis.

The seat sensor 240 detects a state of the seat, such as a position of the seat portion 210, the height of the seat surface, and an angle of the seat back 220, and transmits a detection result to the head unit 10. For example, the seat sensor 240 detects the position of the seat portion 210 relative to the rail on the side of the vehicle. The seat sensor 240 detects the rotation angle of the seat back 220 relative to the seat portion 210. The seat sensor 240 is, for example, an encoder. The seat sensor 240 may be a camera that photographs an inside of the vehicle. In this case, for example, the camera and the head unit 10 calculate the position and posture of the seat in a photographed image by image processing. The seat sensor 240 may be a three-dimensional scanner that scans the inside of the vehicle.

The ECU 50 operates the actuator 230 to control the state of the seat 20 according to an operation of the user to a seat operation portion (not shown) provided in the seat portion 210 or near the seat. As a result, for example, when the user gets on the vehicle, the user operates the seat operation portion to control the state of the seat 20 to a desired state. The ECU 50 acquires identification information of the user from a smartphone or IC tag of the user sitting in the seat and controls the state of the seat 20 to a state determined for each user.

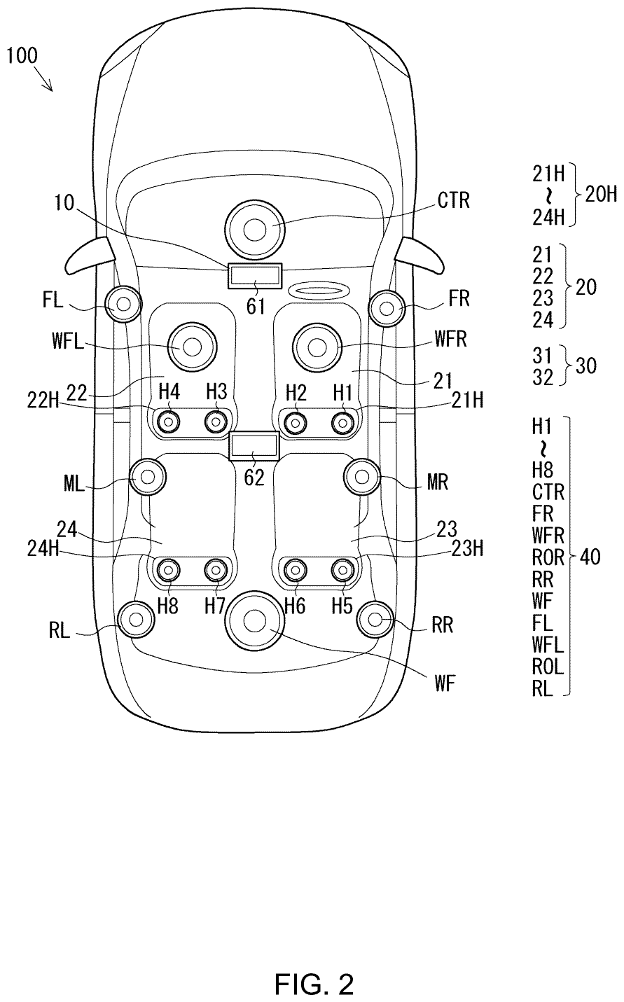

FIG. 2 schematically illustrates an arrangement of the speaker units 40 included in the vehicle. In FIG. 2, a header side of the drawing is referred to as a front of the vehicle, that is, an advancing direction of the vehicle. A footer side of the drawing is referred to as a back of the vehicle, a left side of the drawing is referred to as a left of the vehicle, and a right side of the drawing is referred to as a right of the vehicle.

In an example of FIG. 2, 18 speaker units 40 are provided in the vehicle. The arrangement of the speaker units merely one example and not limited thereto. The speaker units 40 include the headrest speakers H1 to H8 disposed in the headrests 20H (21H to 24H) of the respective seats 20 (21 to 24), and speaker units (hereinafter, referred to as vehicle side speakers) CS (CTR, FR, WFR, MR, RR, WF, FL, WFL, ML, RL) disposed in other places than the seats. That is, in the speaker units 40, the headrest speakers HS move together with the seats 20, and the vehicle side speakers CS are fixed to predetermined positions on a side of a vehicle body and do not move together with the seats 20.

The headrest speaker H1 is disposed on a right side of the headrest 21H in a right front seat (driver seat) 21 and the headrest speaker H2 is disposed on a left side of the headrest 21H. The headrest speaker H3 is disposed on a right side of the headrest 22H in a left front seat (passenger seat) 22 and the headrest speaker H4 is disposed on a left side of the headrest 22H. The headrest speaker H5 is disposed on a right side of the headrest 23H in a right rear seat 23 and the headrest speaker H6 is disposed on a left side of the headrest 23H. The headrest speaker H7 is disposed on a right side of the headrest 24H in a left rear seat 24 and the headrest speaker H8 is disposed on a left side of the headrest 24H.

A speaker unit CTR is a center speaker located in the front center of the vehicle. A speaker unit FR is a speaker located on a front right side of the vehicle. A speaker unit WFR is a woofer located on the front right side of the vehicle and under the right front seat (driver seat) 21. A speaker unit MR is a speaker installed on a right side of a ceiling, approximately in the center of a vehicle cabin in the front-rear direction. A speaker unit RR is a speaker located on a rear right side of the vehicle ceiling. A speaker unit WF is a woofer located in the rear center of the vehicle. A speaker unit FL is a speaker located on a front left of the vehicle. A speaker unit WFL is a woofer located on a front left side of the vehicle and under the left front seat (passenger seat) 22. A speaker unit ML is a speaker installed on a left side of the ceiling, approximately in the center of the vehicle cabin in the front-rear direction. A speaker unit RL is a speaker located on a rear left side of the vehicle ceiling.

Each of the speaker units 40 may be, for example, configured to be wire-connected to the head unit 10 and physically output the sound (vibration of air) by a diaphragm driven by the sound signals (electrical signals) supplied from the head unit 10. Each of the speaker units 40 includes a receiver, a driving portion, and the speakers. The receiver may wirelessly receive the sound signals from the head unit 10, and the driving portion may convert the sound signals into the electrical signals for driving the speakers and supply the converted signals to the speakers to output the sound from the speakers.

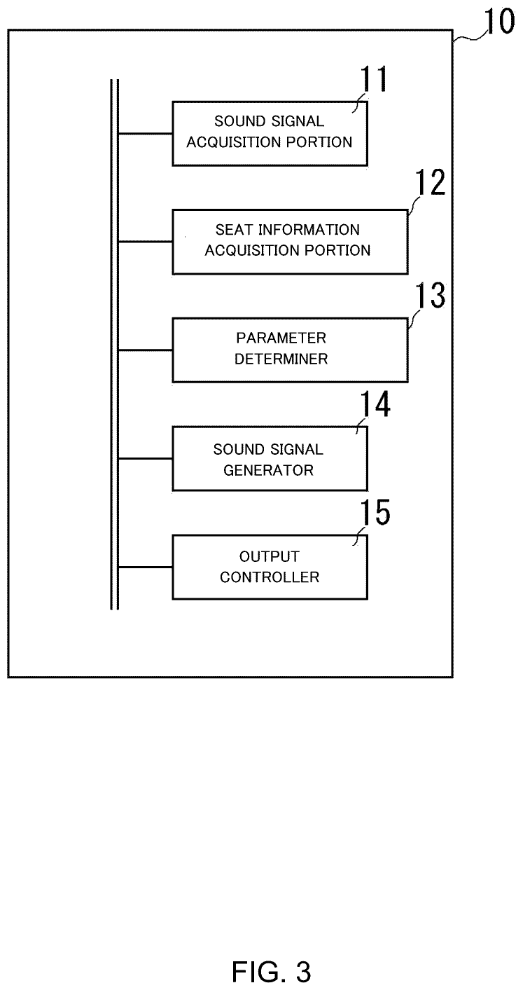

FIG. 3 is a functional block diagram of the head unit 10. A sound signal acquisition portion 11 acquires a sound source signal for reproducing the sound in the vehicle from a sound source device, such as a CD, DVD, USB memory, or memory card. The sound signal acquisition portion 11 may also acquire the sound source signal from an external sound source device, such as a content server or network attached storage (NAS), via a network.

A seat information acquisition portion 12 acquires seat information indicating the state of the seat 20 in the vehicle 1 via the seat sensor 240. The seat information includes, for example, at least one of a position of the seat 20, the height of the seat surface in the seat 20, and the angle of the seat back 220.

A parameter determiner 13 determines parameters when performing reproduction based the seat information. Here, the parameters include a time alignment of the sound signals to be supplied to each of the speaker units 40. The parameters may further include, in addition to the time alignment, at least one of a sound pressure and an increase/decrease value depending on a frequency of the sound to be reproduced. In order to calculate these parameters, the parameter determiner 13, for example, calculates a positional relationship between ears' positions of the user sitting in the seat 20 (hereinafter, also referred to as a sound reception position) and a position of each of the speaker units 40 based on the seat information.

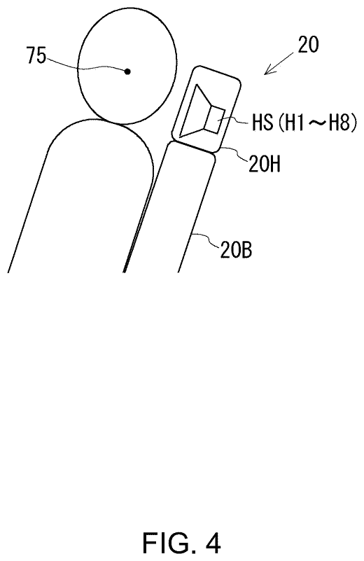

FIG. 4 illustrates a positional relationship between the user sitting in the seat 20 and the seat. For example, when the user having a standard figure sits in the seat 20, the user leans his/her back against the backrest 20B and his/her head is positioned in front of the headrest 20H. Thus, the ears'positions of the user (sound reception position) 75 are naturally determined. The difference between a figure of the user who actually gets on the vehicle and a standard figure may be corrected by user's setting. For example, in a case where the user inputs this difference when getting on the vehicle, the parameter determiner 13 stores this value (setting value) in a memory, the sound reception position may be calculated from this setting value. When the seat sensor 240 has a camera and three-dimensional scanner, the parameter determiner 13 may detect the difference between the figure of the user sitting in the seat 20 and the standard figure and determine the setting value. e. Furthermore, when the headrest 20H has a sensor that performs head-tracking, the parameter determiner 13 may calculate the sound reception position from the head position detected by this sensor. Since each of the headrest speakers HS is fixed to the headrest 20H, the parameter determiner 13 calculates a positional relationship between the sound reception position and the headrest speakers HS by calculating the sound reception position as described above.

Since the vehicle side speakers CS are located on the side of the vehicle, the parameter determiner 13 calculates the positional relationship between the ears' positions (sound reception position) of the user sitting in the seat 20 and the position of each of the speaker units 40 based on the seat information (the position of the seat 20, the height of the seat surface, and the angle of the seat back 220). Here, a positional relationship between the sound reception position and each of the speaker units 40 is, for example, a direction and distance of each of the speaker units 40 with respect to the sound reception position. The direction of each of the speaker units 40 may be indicated, for example, by a rotation angle (hereinafter, also referred to as an elevation angle) when centered on a vertical axis and with the front (e.g., traveling direction of the vehicle) as 0°, and a rotation angle (hereinafter, also referred to as an azimuth angle) when centered on a horizontal axis orthogonal to a vertical direction and with a horizontal direction as 0°. The invention is not limited thereto. For example, a coordinate system is defined in the vehicle, and the position and sound reception position of each of the speaker units 40 are calculated as coordinates to indicate the positional relationship.

If a distance between each of the speaker units 40 and the sound reception position is unequal, the sound from one of the speaker units 40 that is closer arrives faster, while the other of the speaker units 40 that is farther arrives slower, resulting in loss of sound quality. Thus, the parameter determiner 13 determines the time alignment of the sound signals to be supplied to each of the speaker units 40 so that the sound that would be received simultaneously if the distance between each of the speaker units 40 and the sound reception position is equal arrives simultaneously at the sound reception position of the user sitting in each seat. Furthermore, the parameter determiner 13 may determine the sound pressure to be higher as the distance between each of the speaker units 40 and the sound reception position is longer. Moreover, the parameter determiner 13 may increase/decrease a level of the sound at a specific frequency depending on the distance between each of the speaker units 40 and the sound reception position. For example, the parameter determiner 13 increases the level of the sound in a region above a predetermined frequency (high frequency region) as the distance is longer.

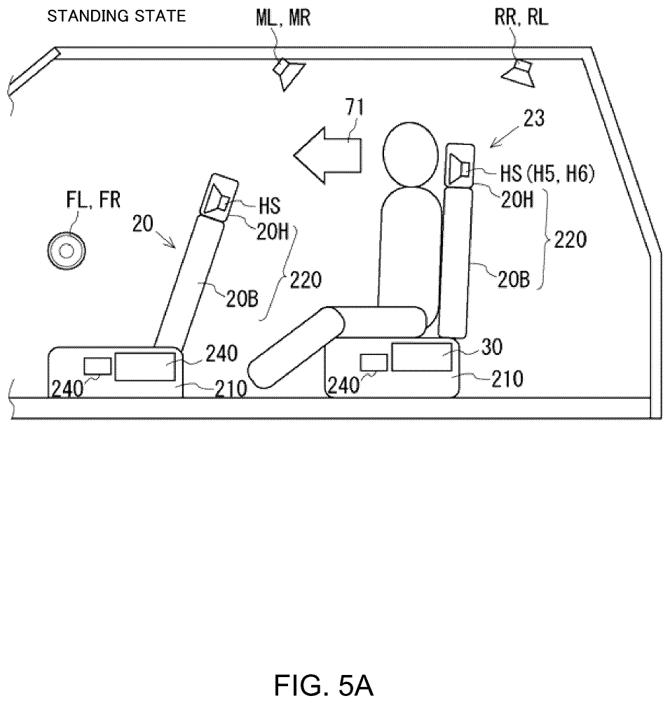

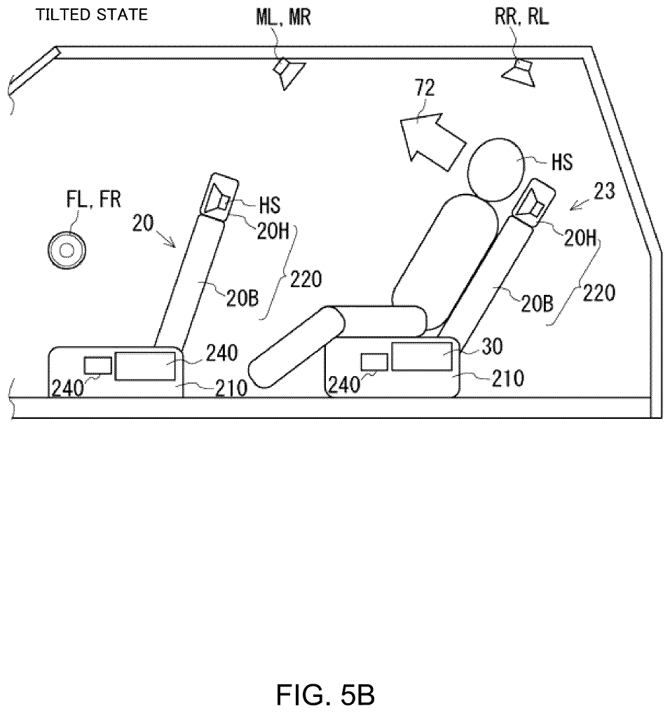

The parameter determiner 13 calculates parameters that control a position at which a sound image is localized according to a posture change of the user caused by rotation of the seat back 220. FIGS. 5A and 5B illustrate a positional relationship between the angle of the seat back 220 and the position at which the sound image is localized. As illustrated in FIG. 5A, when the seat back 200 is in a standing state, the user sitting in the seat 23 faces in the traveling direction of the vehicle as shown by an arrow 71. On the other hand, the seat back 220 is tilted backward and in a tilted state, the user sitting in the seat 23 faces a ceiling side of the vehicle 1 as shown by an arrow 72. Thus, for example, in the tilted state of FIG. 5B, the parameter determiner 13 determines the parameters depending on the angle of the seat back 220 to localize the sound image in a direction (direction of the arrow 72) that the user faces.

For example, when the seat back 220 is in the standing state, the parameter determiner 13 determines the parameters so that sound signals for outputting front sound, i.e., the sound signals of left and right front channels (ch), out of the sound signals, are supplied to the front speaker units FL, FR in the vehicle. As a result, the sound image is formed in front of the user by the sound of the left and right front channels (ch) to be output from the speaker units FL and FR.

When the seat back 220 is in the tilted state, and the user faces in the direction (direction of the arrow 72) of the speaker units ML and MR, the parameter determiner 13 determines the parameters so that the sound signals of the left and right front channels (ch), out of the sound signals, are supplied to the speaker units ML, MR. As a result, the sound image is formed in front of the user in the tilted state by the sound of the left and right front channels (ch) to be output from the speaker units ML and MR.

When the seat back 220 is positioned between the standing and tilted states shown in FIGS. 5A and 5B, that is, the user faces in a direction between the arrows 71 and 72, the parameter determiner 13 distributes the sound signals of the left and right front channels (ch) to the speaker units FL, FR and the speaker units ML, MR, and determines this distribution ratio as parameters. Since the sound image is formed on a side of the speaker having a higher distribution ratio, the parameter determiner 13 determines this ratio depending on the angle of the seat back 220. Similarly, when the user faces in a direction between the speaker units ML, MR and the speaker units RL, RR, the parameter determiner 13 distributes the sound signals of the left and right front channels (ch) to the speaker units ML, MR and the speaker units RL, RR, and determines this distribution ratio as parameters.

A sound signal generator 14 generates the sound signals for outputting the sound from the plurality of the speaker units 40 based on the sound source signal and the parameters.

An output controller 15 supplies the sound signals to each of the plurality of the speaker units 40 via an amplifier 104, and outputs the sound from each of the plurality of the speaker units 40.

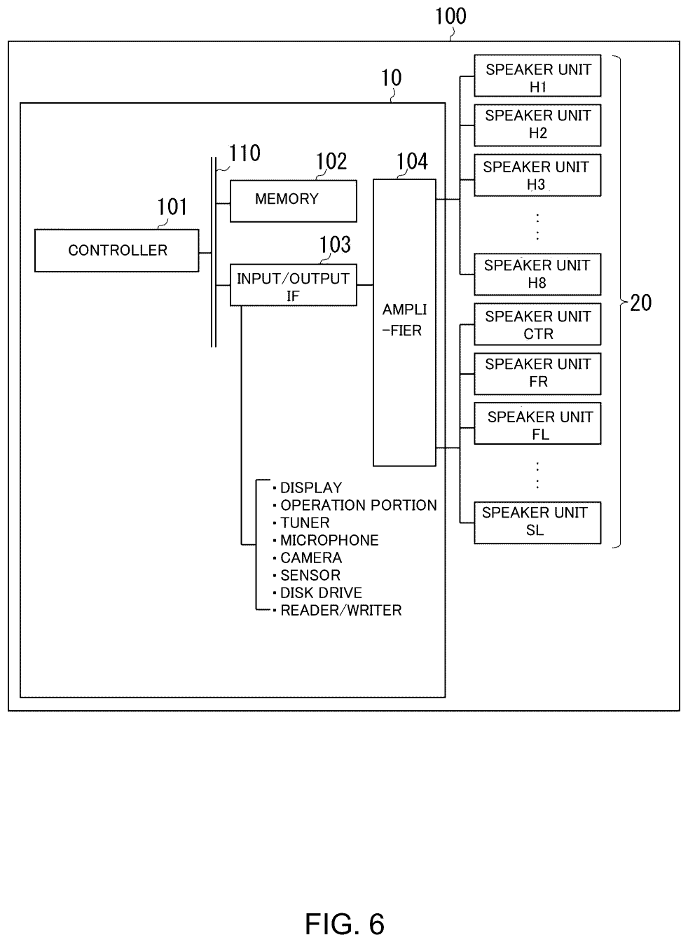

FIG. 6 is a configuration diagram of the sound system 100 including the head unit 10. In FIG. 6, elements necessary to describe the features of this embodiment are mainly illustrated, and general elements are not illustrated for simplicity purposes. In other words, each element illustrated in FIG. 6 is just functional and conceptual, and is not necessarily configured as illustrated in a physical sense. For example, a distributed and/or integrated version of each functional block is not limited to those illustrated, and its entirety or a part thereof may be functionally or physically distributed or integrated in an arbitrary unit depending on various loads, use situations, and the like.

The head unit 10 is, as illustrated in FIG. 6, an information processing apparatus (computer) having a controller 101, a memory 102, an input/output interface (IF) 103 that are interconnected by a connection bus 110, and the amplifier 104. In FIG. 6, the head unit 10 is configured to include the amplifier 104, but the head unit 10 (signal processing apparatus) may be separated from the amplifier 104.

The controller 101 controls the entire head unit. The controller 101 consists of, for example, a central processing unit (CPU), a micro processing unit (MPC), a main storage, and the like. The controller 101 is also referred to as a controller or a processor. The controller 101 is not limited to a configuration with a single processor, but may be a multiprocessor configuration. A signal controller 101 connected by a single socket may be in a multicore configuration. The main storage is, for example, used as a work area of the controller 101, a storage area for programs and data, and a buffer area for communication data. The main storage includes, for example, a random access memory (RAM), or a combination of the RAM and a read only memory (ROM).

The memory 102 is an axillary storage that stores programs executed by the controller 101 and operation setting information. The memory 102 is not limited to an internal storage built in the head unit 10, but may also be an external storage or an external storage, such as a network attached storage (NAS). The memory 102 is, for example, a hard-disk drive (HDD), a solid state drive (SSD), an erasable programmable ROM (EPROM), a flash memory, a USB memory, a memory card, or the like.

The input/output IF 103 is an interface that performs input/output of data to/from other devices, such as a content server, the speaker units 40, the amplifier 104, and an ECU. The input/output IF 103 performs input/output of data to/from, for example, devices, such as a disk drive that reads data from a storage medium, such as a CD or DVD, an operation portion that receives operations by the user, the displays 61, 62 that provide the user with a display, and a communication module. Furthermore, the input/output IF 103 performs input/output of data to/from, for example, devices, such as a tuner that receives radio and television broadcast waves, a reader/writer that reads/writes data in a storage medium, such as a memory card, a camera (seat sensor, head sensor), a microphone, and other sensors. The operation portion is an input means that receives operations by the user and inputs operation information indicating these operations to the controller 101. The operation portion may also be, for example, a button, a switch, a dial (rotating knob), a lever, or the like. The operation portion may also be a touch panel that is provided to be overlapped on a display surface of the display 61. The displays 61, 62 are output means for displaying, for example, information on music reproduction to the user. The communication module is an interface that performs communication with other devices, such as a content server and speaker units, via a communication line. A plurality of the above elements may be respectively provided, or a part of the elements may not be provided.

In the head unit 10, the controller 101 functions as processors, such as the sound signal acquisition portion 11 shown in FIG. 3, the seat information acquisition portion 12, the parameter determiner 13, the sound signal generator 14, and the output controller 15 by executing an application program. However, at least a part of the processes of the processors may be provided by a digital signal processor (DSP), an application specific integrated circuit (ASIC), etc. Some of the processors may be a dedicated large scale integration (LSI), such as a field-programmable gate array (FPGA), or other digital circuits. At least some of the processors may include an analog circuit.

### Signal Processing Method

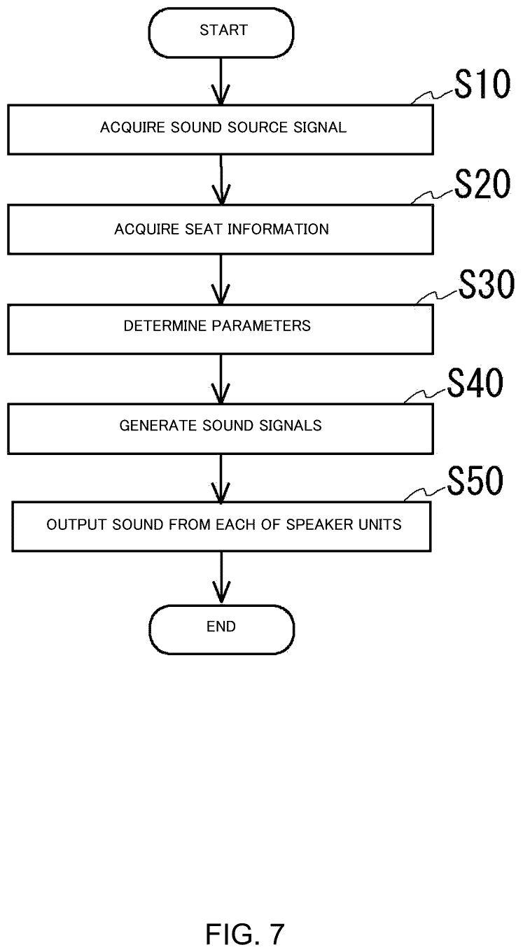

FIG. 7 is a flowchart of a signal processing method according to this embodiment performed by a controller based on a signal processing program. For example, when an accessory power source of the vehicle 1 is turned on, and electric power has been supplied to the head unit 10, or the reproduction of contents has been instructed by the operation of the user, the controller 101 starts the process of FIG. 7. The process of FIG. 7 is repeatedly executed until the accessory power source of the vehicle 1 is turned off, and the operation of the head unit 10 is stopped, or termination is instructed by the operation of the user. The repetition cycle of the process of FIG. 7 may be enough to perform music reproduction in approximately real time. For example, when the sound signals are stored in a buffer for several milliseconds to several seconds, the repetition cycle of the process may be enough to repeat the process several times within this buffer period.

In a step S10, the controller 101 acquires the sound source signal from a sound source device, such as a CD, DVD, semiconductor memory, or the like.

In a step S20, the controller 101 acquires the seat information indicating the position of each seat 20, the angle of the seat back 220, the height of the seat surface, etc. via the seat sensor 240.

In a step S30, the controller 101 determines the parameters based on the seat information to correct variation in the positional relationship with the vehicle side speakers CS due to the seat being moved. For example, the controller 101 adjusts the time alignment of the sound signals to be supplied to each of the speaker units 40 for the variation in a distance between the vehicle side speakers CS and the sound reception position due to a movement of the seat position. The controller 101 determines distribution of the sound signals to be supplied to each of the speaker units 40 depending on the angle of the seat back 220.

In a step S40, the controller 101 generates the sound signals to be supplied to each of the speaker units 40 based on the sound source signal acquired in the step S10 and the parameters determined in the step S30.

In a step S50, the controller 101 supplies the sound signals generated in the step S40 to each of the speaker units 40, and outputs the sound.

### Effect of Embodiment

(1) The head unit 10 (signal processing apparatus) according to this embodiment acquires the seat information indicating the state of the seat 20, determines the parameters when performing reproduction based on the seat information, and generates the sound signals based on the sound source signal and the parameters. As a result, even when the positional relationship between the sound reception position and each of the speaker units 40 varies in accordance with the variation in the state of the seat, the head unit 10 according to this embodiment determines the parameters, such as the time alignment, accordingly, and reproduces the sound by using appropriate sound parameters.
(2) In this embodiment, the seat information includes at least one of the position of the seat 20, the height of the seat surface in the seat, and the angle of the seat back 220. As a result, the head unit 10 grasps the state of the seat, and reproduces the sound by using appropriate sound parameters.
(3) In this embodiment, the parameters include the time alignment of the sound signals to be supplied to each of the speaker units 40. The parameters may further include at least one of the sound pressure of the sound to be output from each of the speakers and the increase/decrease value depending on the frequency of the sound. As a result, the head unit 10 according to this embodiment reproduces the sound by using appropriate sound parameters.
(4) The head unit 10 according to this embodiment replaces the sound signals to be supplied to each of the speaker units 40 depending on the angle of the seat back 220. The head unit 10 distributes the sound signals for outputting the front sound to the plurality of the speakers depending on the angle of the seat back 220. As a result, the head unit 10 according to this embodiment forms the sound image in front of the user depending on the seat back 220.

### Second Embodiment

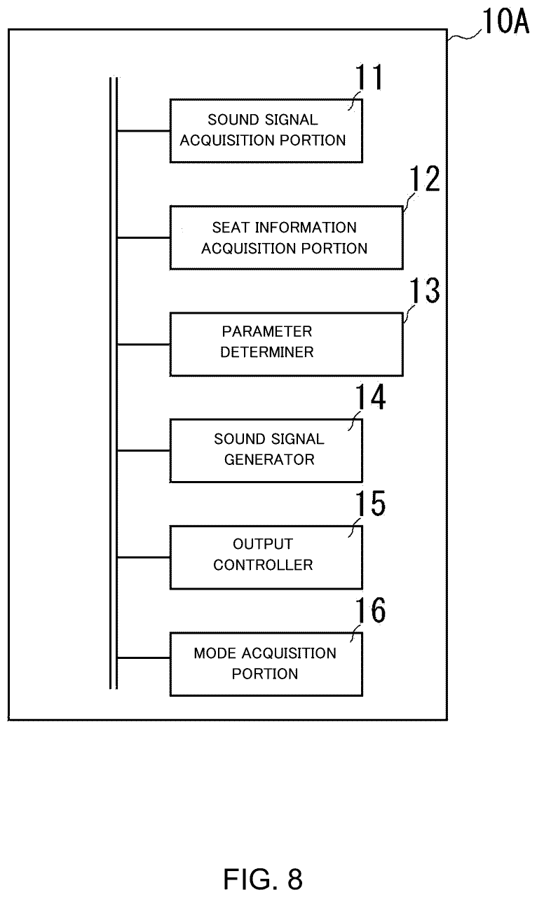

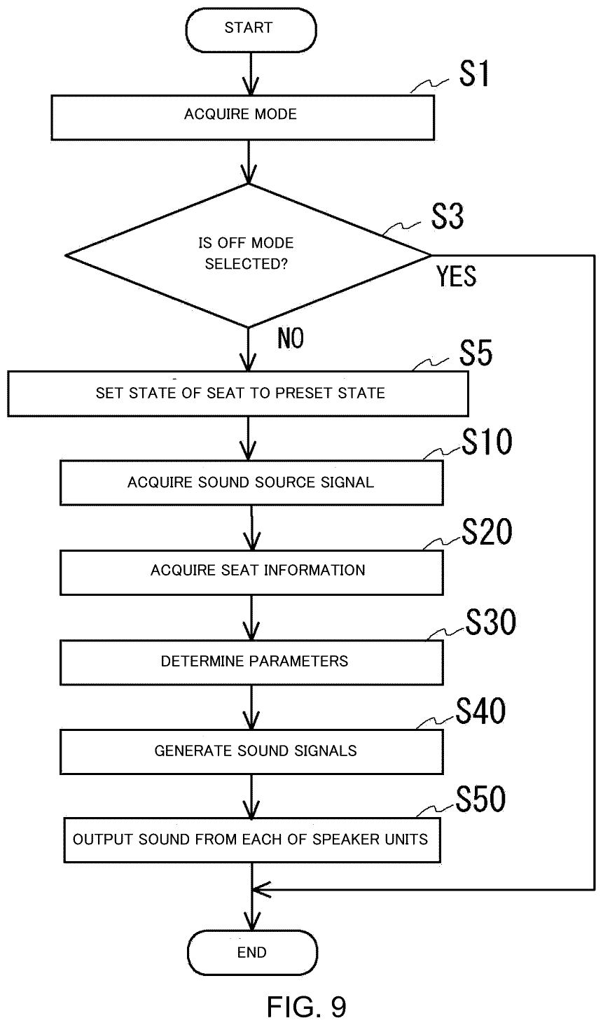

FIG. 8 is a block diagram illustrating a configuration of a head unit 10A according a second embodiment. FIG. 9 illustrates a flow of a signal processing method performed by the head unit 10A according to the second embodiment. Compared to the first embodiment described above, this embodiment differs in the configuration of changing a state of a seat 20 according to a mode selected by a user while other configurations are the same. As a result, in this embodiment, the same constituent elements as those of the first embodiment described above are denoted with the same reference numerals and a description thereof is omitted.

The head unit 10A according to this embodiment, as illustrated in FIG. 8, has a mode acquisition portion 16. When a mode is selected by the user operating an operation portion, the mode acquisition portion 16 performs control of changing the state of the seat 20 according to the selected mode. For example, when the user sets a position of the seat 20, a height of a seat surface in the seat 20, and an angle of a seat back 220 to a desired state, and performs a registration (preset) operation, the head unit 10A detects the state of the seat 20 by the seat sensor 240, and stores the detected state in a memory.

The head unit 10A selects a plurality of modes according to a process of adjusting parameters of FIG. 9 by an operation of the operation portion. The plurality of the modes may be an OFF mode that does not perform a process of FIG. 9 and an ON mode that performs the process of FIG. 9. The user may register a plurality of states of the seat 20, such as Mode A, Mode B, and Mode C, and select one of them.

The process of FIG. 9 is started, for example, when the accessory power source of a vehicle 1 is turned on, and electric power has been supplied to the head unit 10, or the reproduction of contents has been instructed by the operation of the user. The process of FIG. 9 is repeatedly executed until the accessory power source of the vehicle 1 is turned off, and the operation of the head unit 10A is stopped, or termination is instructed by the operation of the user.

In a step S1, a controller 101 acquires the mode selected by the user. In a step S3, the controller 101 determines whether or not the OFF mode is selected. Here, when the OFF mode is selected (Yes in the step S3), the controller 101 ends the process of FIG. 9. When the ON mode is selected (No in the step S3), the controller 101 moves to a step S5.

In the step S5, the controller 101 reads the state of the seat that has been preset from the memory, transmits a control signal to an actuator 230 to set the state of the seat 20 to the preset state. The process after the step S10 is the same as the process shown in FIG. 7 described above. That is, the controller 101 determines the parameters based on the state of the seat after presetting in the step S5, and reproduces the sound.

As a result, the head unit 10A according to this embodiment changes the state of the seat according to the mode selected by the user, and then, reproduces the sound by using appropriate sound parameters in accordance with the state of the seat 20 after this change.

While the invention has been shown and described in detail, the foregoing description is in all aspects illustrative and not restrictive. It is therefore understood that numerous other modifications and variations can be devised without departing from the scope of the invention.

What is claimed is:

1. A signal processing apparatus comprising a controller configured to:
(i) acquire a sound source signal for reproducing sound in a vehicle;
(ii) acquire seat information indicating a state of a seat in the vehicle;
(iii) determine parameters for reproduction based on the seat information; and
(iv) generate sound signals for outputting the sound from a plurality of speakers provided in the vehicle based on the sound source signal and the parameters.

2. The signal processing apparatus according to claim 1, wherein
the seat information includes at least one of a position of the seat, a height of a seat surface of the seat, and an angle of a seat back.

3. The signal processing apparatus according to claim 1, wherein
the parameters include a time alignment of the sound signals to be supplied to each of the plurality of the speakers.

4. The signal processing apparatus according to claim 3, wherein
the parameters further include at least one of a sound pressure of sound to be output from each of the plurality of the speakers and an increase/decrease of a level of the sound at a specific frequency.

5. The signal processing apparatus according to claim 1, wherein
the controller replaces the sound signals to be supplied to each of the plurality of the speakers depending on an angle of a seat back of the seat.

6. The signal processing apparatus according to claim 1, wherein
the controller distributes the sound signals for outputting front sound in the vehicle to the plurality of the speakers depending on an angle of a seat back of the seat.

7. The signal processing apparatus according to claim 1, wherein
the controller changes the state of the seat according to a mode selected by a user from a plurality of modes, and acquires seat information indicating a state of the seat after change.

8. A signal processing method executed by a controller, the method comprising:
(a) acquiring a sound source signal for reproducing sound in a vehicle;
(b) acquiring seat information indicating a state of a seat in the vehicle;
(c) determining parameters for reproduction based on the seat information; and
(d) generating sound signals for outputting the sound from a plurality of speakers provided in the vehicle based on the sound source signal and the parameters.

9. A sound system comprising:
the signal processing apparatus according to claim 1;
a sensor that detects a state of the seat; and
a plurality of speakers that output sound based on the sound signals.
